(19) United States
(12) Patent Application Publication
(10) Pub. No.: US 2025/0265534 A1
(43) Pub. Date: Aug. 21, 2025

(54) USE OF MACHINE-LEARNED PRESENT AND FUTURE MODELS FOR DELIVERY PREDICTIONS AND DELIVERY BATCHING

(71) Applicant: Maplebear Inc., San Francisco, CA (US)

(72) Inventors: Rahul Makhijani, Daly City, CA (US); Xiangdong Liang, Arlington, MA (US)

(21) Appl. No.: 18/443,853

(22) Filed: Feb. 16, 2024

(51) Int. Cl. G06Q 10/083

(52) U.S. Cl. CPC G06Q 10/083

(57) ABSTRACT

A system uses both a present cost model and a future cost model trained on logged order data to compute a prediction of costs for delivering orders either without further delay, or with delay to allow time to potentially batch orders for delivery with other orders (and thereby reduce delivery cost). A comparison of the outputs of the present and future cost models is used to determine whether to delay assigning the order in expectation of batching order with other orders. Calculations may additionally be performed for the constituent orders of an order batch to apportion the delivery cost saving resulting from batching among the different orders. The system can analyze previously-logged data associated with prior orders to obtain features that characterize the prior orders. Using these features, and the known actual delivery costs from the prior completed deliveries, the system can train the present and future cost models.

### BACKGROUND

Concierge systems, which enable assistants to assist a customer with the customer's errands or other personal business, are of value to both the assistants and the customers, providing the customers with the ability to accomplish tasks for which they lack the time or ability, and the assistants with flexible employment opportunities.

Some concierge systems facilitate assistants for performing shopping for groceries or other items on behalf of customers. In such cases, customers submit orders for items to be fulfilled (i.e., obtained from a retailer location and delivered to the customer), and the concierge system makes fulfillment of the customer orders available to assistants by releasing the orders to a pool that assistants may claim. However, it is difficult to assess when to release orders for fulfillment most efficiently. For example, immediately releasing a new customer order to be claimed by assistants results in fast fulfillment, but delaying releasing of the order until it can be combined (or “batched”) with other customer orders can reduce average order fulfillment costs by allowing a single assistant to fulfill all the orders in the batch in a single trip, reducing costs for the customers. But delaying fulfillment until an order can be batched increases fulfillment time, which decreases customer satisfaction. Thus, there is a tradeoff between fulfillment speed and fulfillment cost. However, it is difficult to determine how best to balance the tradeoff because predicting the relevant metrics cannot be done mentally due to the complexity.

### SUMMARY

In accordance with one or more aspects of the disclosure, a system uses both a present cost model and a future (or “counterfactual”) cost model trained on logged order data to compute a prediction of costs for delivering orders either without further delay, or with delay to allow time to potentially batch orders for delivery with other orders (and thereby reduce delivery cost).

When an order arrives from a user, the predicted present and future costs derived using the cost models are compared (e.g., by determining whether delaying release of the order is likely to result in a sufficient delivery cost reduction to justify the probable delivery delay), and the comparison is used to determine whether to delay releasing the order.

Calculations may additionally be performed for the constituent orders of an order batch to apportion the delivery cost saving resulting from batching among the different orders. This apportioning can be used to distribute the delivery costs more equitably among the users associated with the orders in the batch, and/or to determine whether an existing set of orders should be batched together.

The system can analyze previously-logged data associated with prior orders to obtain or derive features that characterize the prior orders, such as item counts and types of batches and orders, days and times of deliveries, prior system estimates of delivery times relative to actual delivery times, and the like. Using these features, and the known actual delivery costs from the prior completed deliveries, the system can train the present and future cost models.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates components of the batching module 250 of FIG. 2, according to some embodiments.

FIG. 4 is a flowchart of steps taken by the batching module of FIG. 2 when determining whether to delay release of an order for fulfillment, according to some embodiments.

### DETAILED DESCRIPTION

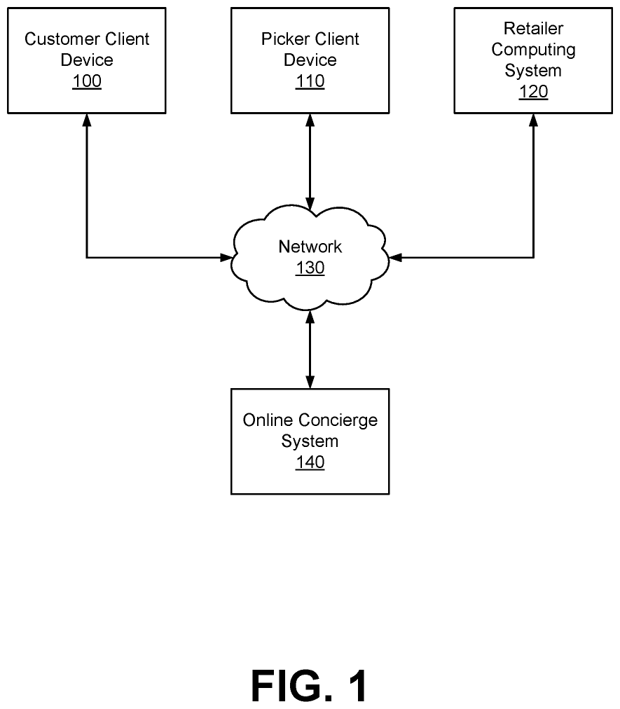

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

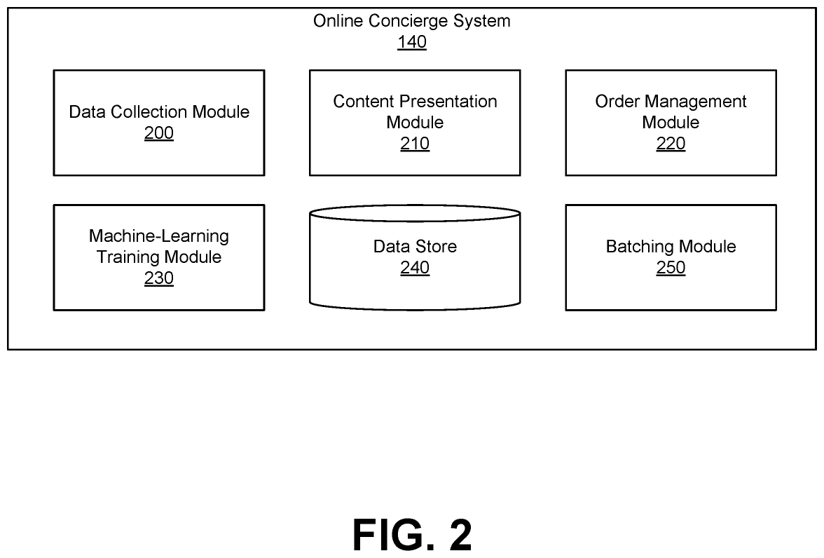

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The online concierge system 140 additionally includes a batching module 250 that estimates costs of fulfillment (e.g., delivery) at various times and in various order batch sizes and that applies those estimates to better determine how optimally to schedule, batch, and deliver orders to customers. (The scheduling, batching, and delivering involved in order fulfillment are sometimes referred to herein for simplicity simply as “delivery.”)

The online concierge system 140 maintains an unclaimed order pool of received orders that have not yet been claimed by pickers. That is, after an order is received from a customer, it is ultimately placed into the online concierge system 140, at which point it becomes available for pickers to claim; once a picker claims an order in the unclaimed order pool (e.g., by selecting it within a user interface showing the orders of the unclaimed order pool), it is assigned to that picker and is removed from the unclaimed order pool so that it is no longer available for fulfillment by other pickers. As is now described below, the batching module 250 determines whether to immediately release an order to the unclaimed order pool, or whether to delay doing so, instead holding the order in a batching candidate pool in the hopes that meanwhile the order will able to be batched with other orders to reduce total delivery cost.

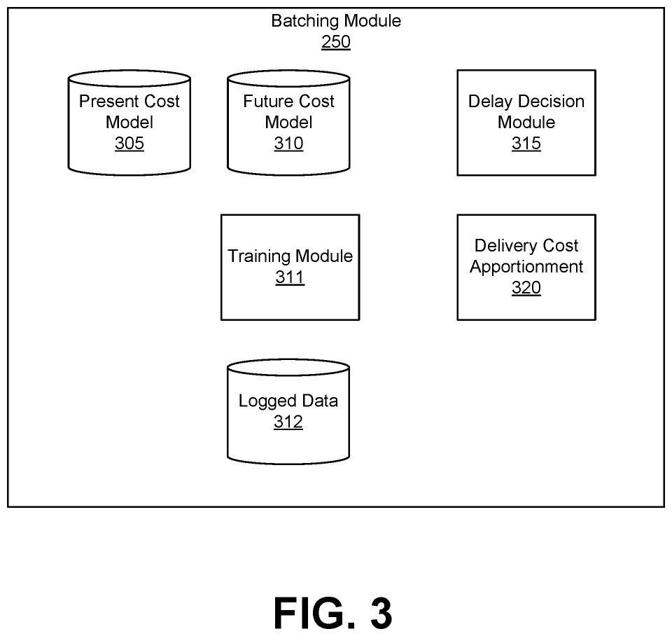

FIG. 3 illustrates components of the batching module 250 of FIG. 2, according to some embodiments.

The batching module 250 includes logged data 312 describing prior activities of the online concierge system 140, such as orders, batching of orders, deliveries of orders, and the like. The logged data 312 can be used—either directly, or with further processing of the raw data—as features for training machine-learned models used to predict delivery costs.

The batching module 250 also includes a present cost model 305 that estimates the cost of delivery of a batch of orders if the batch were delivered without any delay in releasing it from the batching candidate pool to the unclaimed order pool for delivery. (A “batch” of orders is any number of orders—e.g., 1, 2, or 3 orders—fulfilled by the same picker as part of the same overall delivery trip. Each order is for a particular customer and may have any number of associated items.) The present cost model 305 is a machine-learned model trained on features of known prior batches. Such features include characteristics known at the time of the assignment of the batch, such as the number of orders in the batch, the number of items in each order, the total number of items in the batch, the location(s) of the items to be obtained, and/or the location(s) to which the items are to be delivered; for training purposes, the “label” indicating the model output being correlated with the input features is the cost of delivery as later determined by the online concierge system 140. The input features, when provided to the present cost model 305, cause the present cost model 305 to output an estimated cost of delivery of the batch if released for delivery without delay.

The batching module 250 additionally includes a future cost model 310 (also sometimes referred to as a counterfactual cost model). Unlike the present cost model 305—which estimates the cost of delivery of the batch if released for fulfillment without additional delay—the future cost model 310 represents the cost of delivery of a particular order during a given future time window (e.g., the next 90 minutes), possibly in combination with additional orders combined into a batch before fulfillment begins. In some embodiments, the future cost model 310 returns a single estimated delivery cost of the order if delivered during the future time window. In other embodiments, the future cost model 310 instead returns a set of tuples including sizes of possible batches in which the order could be included, along with the predicted delivery cost and probability of each. For example, such a set might be {<1, $5, 0.5>, <2, $4, 0.30>, <3, $3, 0.20>}, representing a prediction that a batch of size 1 would result in a delivery cost for that order of $5, and that such a batch size is 50% likely to occur; that a batch of size 2 would result in a delivery cost for that order of $4, and that such a batch size is 30% likely to occur; and that a batch size of 3 would result in a delivery cost for that order of $3, and that such a batch size is 20% likely to occur. In embodiments returning a set of tuples, a single estimated delivery cost of the order can be determined by weighting the estimated delivery cost of each possible batch size by its estimated probability (e.g., ($5*0.5)+($4*0.3)+($3*0.2)=$4.30, in the prior example).

The features that are provided as input for the future cost model 310—and used in training for the model 310—may include, for example, batch features including a zone in which the order was obtained or to which the order was to be delivered, a time or times at which the items of the order(s) of the batch were picked, a time or times at which the items of the order(s) of the batch were delivered, a total delivery distance traveled to deliver the order(s), a batch size (number of orders), a total number of items types in the batch (e.g., 3 bottles of the same juice are a single type of item), and/or a total number of item units in the batch (e.g., 3 bottles of the same juice are 3 distinct units). The features may also include time features, such as the day of the week, the hour of the day, or the holiday status, or the time(s) of receipt of the orders of the batch, of their picking, and/or of their deliveries. The features may also include batching features, such as a number of deliveries to be assigned to a given zone or a number of deliveries due within a timeframe. The features may also include estimated time of arrival (ETA) features, such as an ending time of a delivery window, and/or a batch size prediction. The features also include values (labels) not initially known at the time that the orders of the batch were received, but later determined, such as batch size (number of orders in the batch) and a total batch delivery cost. The training of the present cost model 305 correlates the total batch delivery cost with the other batch features, so that when those other batch features are provided as input, the present cost model outputs a predicted batch delivery cost if the batch were assigned for fulfillment at the present moment, without additional delay.

In some embodiments, a training module 311 trains the present cost model 305 and/or the future cost model 310 based on their respective features. The training features may be obtained from the logged data 312, either directly, or as a result of additional preprocessing. The training module 311 may also retrain the models 305, 310 based on the additional data obtained from prior decisions of the batching module 250 about how to batch orders and the actual data logged in association with the fulfillment of those batched orders, such as their actual delivery cost, actual time of arrival, whether they were late, etc.

The batching module 250 includes a delay decision module 315 that uses the present and future cost models 305, 310 to determine whether it is worthwhile to delay releasing an existing order to the unclaimed order pool for fulfillment so as to batch the order with other orders. As noted above, delaying fulfillment of an order has the negative consequence of increasing the amount of time that the customer must wait until receiving the ordered items, but the potential positive consequence of reducing the cost of the delivery by allowing a single picker to obtain and deliver the items of multiple orders within a single trip, rather than having to make multiple separate trips. In one embodiment, the delay decision module 315 compares the estimated cost of delivering the order without delay, with the estimated cost of delivering the order after delay at some point during a given future delivery window and determines the resulting degree of cost savings from delay. Specifically, the delay decision module 315 obtains the features of the present cost model 305 and provides them as input to the model 305, which produces an estimated cost of delivery when delivering the order without delay. The delay decision module 315 additionally obtains the features of the future cost model 310 and provides them as input to the model 310, which produces an estimated cost of delivery (or estimates and probabilities for different batch sizes, from which it can derive a single estimated cost based on the probability weightings) when delivering the order within a given future delivery window (e.g., the next 90 minutes). The delay decision module 315 compares the estimated present cost of delivery with the estimated future cost of delivery (which will likely be less due to cost savings due to possible batching) to compute the estimated cost savings of delay. In some embodiments, if the estimated cost savings is above some given threshold (e.g., an absolute savings such as 50 cents, or a savings per time, such as 0.5 cents per minute), the delay decision module 315 delays releasing the order to the unclaimed order pool for fulfillment, on the assumption that other orders will subsequently arrive that can be efficiently combined with the current order. (The batching module 250 includes functionality to identify which orders can likely be efficiently batched with which other orders. For example, orders that are from the same retailer, and that are being delivered to locations that are relatively geographically proximate, or that are roughly on the same route from the retailer, tend to be efficient to batch together. These identified batching candidate orders can then be evaluated to more particularly quantify whether batching together would, in fact, result in sufficient additional benefit for each order, as described in more detail below.)

The batching module 250 also includes a delivery cost apportionment module 320 that determines how to apportion the delivery cost of a batch among the different customer orders within the batch, in view of the relative savings and delays associated with each. This cost apportionment can be used to equitably allocate the aggregate delivery fee among the different customers in the batch, and can also be used to determine whether a given set of orders that has been received would be beneficial to combine together into a batch. The future cost model 310 can be applied to determine the costs of fulfillment of multiple batched orders. For example, the cost of fulfillment when batching an order A with an order B can be computed to determine the estimated fulfillment cost for A when in a batch of size 2, and the estimated fulfillment cost for B when in a batch of size 2, and adding those estimates.

The following describes computations for apportioning cost savings for a batch of three existing orders. Consider a triple ACB originating from a single retailer that consists of three orders {A, B, C}, where A is delivered first, followed by C, and finally B. The cost savings S derived from delivering the triple as a batch rather than individually is given by the equation:

$$S = ( Cost of fulfilling A + cost of fulfilling B + cost of fulfilling C - cost of fulfillment of ACB )$$

Further consider the following three incremental cost savings:

$${s}_{1} = min \{ Cost of A + Cost of CB , cost of A + cost of BC \} - Cost of ACB$$

$${s}_{1} = min \{ Cost of B + Cost of A C , cost of B + cost of CA \} - Cost of ACB$$

$${s}_{3} = min \{ cost of C + cost of AB , cost of C + cost of BA \} - cost of ACB$$

The delivery level cost attribution is in the ratio s₁:s₂:s₃. The incremental delivery cost savings S_{A} for delivery A would be:

$${S}_{A} = \frac{s 1}{s 1 + s 2 + s 3} S$$

The incremental cost savings S_{B} and S_{C} are computed similarly.

In one embodiment, orders A, B, and C are batched together if the following condition is met:

$$( \frac{{S}_{A}}{{t}_{A}} , \frac{{S}_{B}}{{t}_{B}} , \frac{{S}_{C}}{{t}_{C}} ) \geq {c}_{T}$$

where t_{A}, t_{B}, and t_{C} are the incremental delivery time increases of orders A, B, and C, respectively, as may be determined by a delivery time estimation model based on features of the respective orders. The incremental delivery time increases represent the time difference in fulfilling the delivery as a batch with one item versus the corresponding batch with three items. That is, t_{A}=deliveryTime(ABC)−deliveryTime(A), for example. Thus, the above batching condition means that A, B, and C will be batched together only if each of the ratios of incremental cost savings to incremental time increases—(S_{A}/t_{A}), (S_{B}/t_{B}), and (S_{C}/t_{C}) —are at least c_{T}. That is, the incremental cost savings for each order, relative to the incremental time increases for that order, must be at least some given minimum level of value.

The following describes computations for apportioning cost savings for a batch of two orders. Consider a double AB originating from a single retailer that consists of two deliveries {A, B}, where A is delivered first, followed by B. The cost savings S derived from the double is given by the equation:

$$( \frac{S}{2 {t}_{A}} , \frac{S}{2 {t}_{B}} ) \geq {c}_{D}$$

The savings in case of a double would be equally attributed to both the deliveries of A and of B. In one embodiment, orders A, B, and C are batched together if the following condition is met:

$$S = ( Cost of fulfilling A ) + ( cost of fulfilling B ) - ( cost of fulfilling AB together ) .$$

In one embodiment, the thresholds c_{T} and c_{D} are computed via a simulation of past known orders.

Although the above provides examples of batches with three and two items, respectively, similar calculations can be performed for batches with greater numbers of orders.

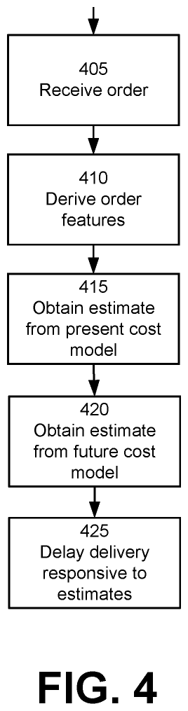

FIG. 4 is a flowchart of steps taken by the batching module 250 when determining whether to delay assignment of fulfillment of an order, according to some embodiments. Alternative embodiments may include more, fewer, or different steps from those illustrated in FIG. 4, and the steps may be performed in a different order from that illustrated in FIG. 4. These steps may be performed by an online concierge system (e.g., online concierge system 140). Additionally, each of these steps may be performed automatically by the online concierge system without human intervention.

In step 405, an order is received. The order includes a number of items, a location at which to obtain the items, a location to which to deliver the items, and the like.

In step 410, the batching module 250 derives features associated with the order. The features may be known properties of the order, or values derived from those known properties.

In steps 415 and 420, some or all of the derived features are provided as input to the present cost model 305 and to the future cost model 310 to derive estimates of delivery cost if the order is assigned without delay and with delay, respectively. (The features provided to the present cost model 305 and the future cost model 310 need not be the same.)

In step 425, responsive to the present and future delivery cost estimates, assignment of the delivery for fulfillment is delayed in order to provide an opportunity for other orders to be received that may be batched with the order to lower overall delivery costs. For example, the difference between the present and future estimated delivery costs may be compared, and if their comparison indicates a sufficiently large reduction of delivery cost, assignment of fulfillment of the order may be delayed.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
maintaining an unclaimed order pool of orders received from users and available to be claimed by pickers for fulfillment on behalf of the users, and a batching candidate pool of orders not yet available to be claimed by pickers;
receiving, from a user, an order for delivery of a set of items to an address of the user;
adding the order to the batching candidate pool;
deriving, from the order, a set of features characterizing the order;
providing the set of features as input to a machine-learned present cost model to obtain a first estimate representing an estimated delivery cost if the order were released from the batching candidate pool to the unclaimed order pool without attempting batching;
providing the set of features as input to a machine-learned counterfactual cost model to obtain a plurality of tuples, each tuple comprising:
a possible batch size,
an estimated delivery cost if the order were released to the unclaimed order pool during a given future time window allowing for a possibility of batching the order with orders of other users, and
a probability associated with the estimated delivery cost;
determining, based at least in part on the first estimate and on the tuples, whether to delay release of the order to the unclaimed order pool in order to attempt batching of the order; and
responsive to determining that the release of the order to the unclaimed order pool should be delayed, delaying release of the order to the unclaimed order pool.

2. The method of claim 1, wherein delaying release of the order comprises:
generating a second estimated delivery cost based on the plurality of tuples; and
determining that the second estimated delivery cost is at least a given threshold degree lower than the first estimate.

3. The method of claim 1, further comprising:
during the future time window, receiving a second order for delivery of another set of items to another address of a second user;
determining that the set of items and the other set of items are to be obtained at a same retailer location;
determining that the address and the other address are within a threshold distance of each other; and
responsive at least in part to determining that the set of items and the other set of items are to be obtained at the same retailer and determining that the address and the other address are within a threshold distance of each other, evaluating batching the other order for delivery along with the order.

4. The method of claim 1, further comprising:
during the future time window, receiving another order for delivery of another set of items to another address of another user; and
batching the other order for delivery along with the order.

5. The method of claim 4, further comprising retraining the counterfactual cost model based on features obtained from data log about subsequent delivery of the batch.

6. The method of claim 4, further comprising apportioning delivery costs between the order and the other order, the apportioning comprising computing a batching cost savings value as a sum of a cost of delivery of the order and a separate cost of delivery of the other order, less a cost of delivering the order and the other order together.

7. The method of claim 6, wherein the apportioning further comprises computing a ratio of a cost savings for the order with an amount of additional delivery time for the order.

8. The method of claim 4, further comprising determining whether to batch the other order for delivery along with the order, wherein the determining comprises:
generating, using the machine-learned counterfactual cost model, an estimated cost of delivering the order and the other order as a batch;
generating incremental delivery cost savings of the estimated cost of delivering the order and the other order as a batch relative to a cost total cost of delivering the order and the other order separately;
generating incremental delivery time increases of delivering the order and the other order as a batch rather than separately; and
identifying whether each of the following is at least a threshold value:
a ratio of an incremental delivery cost savings for the order relative to an incremental delivery time increase for the order, and
a ratio of an incremental delivery cost savings for the other order relative to an incremental delivery time increase for the other order.

9. The method of claim 1, wherein the features comprise at least one of: a location of a retailer from which to obtain items of the order, a location corresponding to the address of the user, number of items in the order, number of types of items in the order, a distance travelled for the order, a time of the order, or an estimated time of arrival of the order.

10. A non-transitory computer-readable medium storing instructions that, when executed by a processor, cause the processor to perform operations comprising:
maintaining an unclaimed order pool of orders received from users and available to be claimed by pickers for fulfillment on behalf of the users, and a batching candidate pool of orders not yet available to be claimed by pickers;
receiving, from a user, an order for delivery of a set of items to an address of the user;
adding the order to the batching candidate pool;
deriving, from the order, a set of features characterizing the order;
providing the set of features as input to a machine-learned present cost model to obtain a first estimate representing an estimated delivery cost if the order were released from the batching candidate pool to the unclaimed order pool without attempting batching;
providing the set of features as input to a machine-learned counterfactual cost model to obtain a plurality of tuples, each tuple comprising:
a possible batch size,
an estimated delivery cost if the order were released to the unclaimed order pool during a given future time window allowing for a possibility of batching the order with orders of other users, and
a probability associated with the estimated delivery cost;
determining, based at least in part on the first estimate and on the tuples, whether to delay release of the order to the unclaimed order pool in order to attempt batching of the order; and
responsive to determining that the release of the order to the unclaimed order pool should be delayed, delaying release of the order to the unclaimed order pool.

11. The computer-readable medium of claim 10, wherein delaying release of the order comprises:
generating a second estimated delivery cost based on the plurality of tuples; and
determining that the second estimated delivery cost is at least a given threshold degree lower than the first estimate.

12. The computer-readable medium of claim 10, the operations further comprising:
during the future time window, receiving a second order for delivery of another set of items to another address of a second user;
determining that the set of items and the other set of items are to be obtained at a same retailer location;
determining that the address and the other address are within a threshold distance of each other; and
responsive at least in part to determining that the set of items and the other set of items are to be obtained at the same retailer and determining that the address and the other address are within a threshold distance of each other, evaluating batching the other order for delivery along with the order.

13. The computer-readable medium of claim 10, the operations further comprising:
during the future time window, receiving another order for delivery of another set of items to another address of another user; and
batching the other order for delivery along with the order.

14. The computer-readable medium of claim 13, the operations further comprising retraining the counterfactual cost model based on features obtained from data log about subsequent delivery of the batch.

15. The computer-readable medium of claim 13, the operations further comprising apportioning delivery costs between the order and the other order, the apportioning comprising computing a batching cost savings value as a sum of a cost of delivery of the order and a separate cost of delivery of the other order, less a cost of delivering the order and the other order together.

16. The computer-readable medium of claim 15, wherein the apportioning further comprises computing a ratio of a cost savings for the order with an amount of additional delivery time for the order.

17. The computer-readable medium of claim 13, the operations further comprising determining whether to batch the other order for delivery along with the order, wherein the determining comprises:
generating, using the machine-learned counterfactual cost model, an estimated cost of delivering the order and the other order as a batch;
generating incremental delivery cost savings of the estimated cost of delivering the order and the other order as a batch relative to a cost total cost of delivering the order and the other order separately;
generating incremental delivery time increases of delivering the order and the other order as a batch rather than separately; and
identifying whether each of the following is at least a threshold value:
a ratio of an incremental delivery cost savings for the order relative to an incremental delivery time increase for the order, and
a ratio of an incremental delivery cost savings for the other order relative to an incremental delivery time increase for the other order.

18. The computer-readable medium of claim 10, wherein the features comprise at least one of: a location of a retailer from which to obtain items of the order, a location corresponding to the address of the user, number of items in the order, number of types of items in the order, a distance travelled for the order, a time of the order, or an estimated time of arrival of the order.

19. A system comprising a processor and a non-transitory computer-readable medium storing instructions that, when executed by the processor, cause the processor to perform operations comprising:
maintaining an unclaimed order pool of orders received from users and available to be claimed by pickers for fulfillment on behalf of the users, and a batching candidate pool of orders not yet available to be claimed by pickers;
receiving, from a user, an order for delivery of a set of items to an address of the user;
adding the order to the batching candidate pool;
deriving, from the order, a set of features characterizing the order;
providing the set of features as input to a machine-learned present cost model to obtain a first estimate representing an estimated delivery cost if the order were released from the batching candidate pool to the unclaimed order pool without attempting batching;
providing the set of features as input to a machine-learned counterfactual cost model to obtain a plurality of tuples, each tuple comprising:
a possible batch size,
an estimated delivery cost if the order were released to the unclaimed order pool during a given future time window allowing for a possibility of batching the order with orders of other users, and
a probability associated with the estimated delivery cost;
determining, based at least in part on the first estimate and on the tuples, whether to delay release of the order to the unclaimed order pool in order to attempt batching of the order; and
responsive to determining that the release of the order to the unclaimed order pool should be delayed, delaying release of the order to the unclaimed order pool.

20. The system of claim 19, wherein delaying release of the order comprises:
generating a second estimated delivery cost based on the plurality of tuples; and
determining that the second estimated delivery cost is at least a given threshold degree lower than the first estimate.
